(19) United States
(12) Patent Application Publication
(10) Pub. No.: US 2016/0110744 A1
(43) Pub. Date: Apr. 21, 2016

(54) HYPERLOCAL RATING SERVICE

(71) Applicant: Ratingz, Inc., Sunnyvale, CA (US)

(72) Inventor: Robert Nicholson, Sunnyvale, CA (US)

(21) Appl. No.: 14/514,720

(22) Filed: Oct. 15, 2014

(51) Int. Cl. G06Q 30/02; H04W 4/02; H04W 4/14

(52) U.S. Cl. CPC G06Q 30/0205; H04W 4/14; G06Q 30/0201; H04W 4/021

(57) ABSTRACT

A method and system for acquiring ratings of local businesses accepts a rating submitted by an individual who is associated with a location near a physical presence of a rated business. Ratings are acquired by receiving from a rater a proposal to submit a rating of a business, identifying a location of the rater, verifying the location of the rater, defining a locality encompassing the location of the rater, determining that the business's local presence is contained in the locality, accepting the rating from the rater, and storing the rating to a database. Several techniques are disclosed for verifying the location of the rater.

### TECHNICAL FIELD

The present disclosure relates generally to ratings of businesses and other providers of goods and services, and more specifically to acquiring ratings from raters who have a verified association with a locality, the rated businesses being associated with the locality.

### BACKGROUND

Internet rating services, which allow users to enter and retrieve customer ratings of businesses, are a well-established type of web site.

It has long been recognized, though, that the information provided by Internet rating services is vulnerable to compromise in several ways. For example, a business can inflate its overall rating by impersonating its own customers and submitting bogus positive ratings. A business can also damage a competitor's rating by impersonating the competitor's customers and submitting bogus negative ratings. Furthermore, parties who have no relationship with a business may submit false ratings for malicious reasons, or as a paid service to businesses that want to distort their own ratings or competitors' ratings.

The present disclosure introduces features which may make an Internet rating service less vulnerable these and other types of compromise due to ratings submitted by parties other than legitimate customers of a rated business.

### SUMMARY

This summary introduces the present disclosure in a simplified form that is further described in the Detailed Description below. This summary is not intended to identify essential features of the present disclosure, nor is it intended for use as an aid in determining the scope of the claimed subject matter.

Many aspects of the present disclosure are directed toward ensuring that ratings of a business are accepted only from parties (raters) who are associated with a location near the rated business; for example, from raters with a home address or a workplace address near the rated business. Such ratings are called hyperlocal ratings. A rating service that accepts only hyperlocal ratings is called a hyperlocal rating service.

In one example embodiment, a method for qualifying and accepting ratings is disclosed. A proposal to submit a rating of a business is received by a processor from a rater; the processor identifies and verifies a location of the rater and defines a locality encompassing the location of the rater; the processor determines whether the business is contained in the locality; and if the business is contained in the locality, the processor accepts and stores the rating.

Identifying a rater's location means determining a location nominally associated with the rater. Verifying a rater's location means determining that the identified location of the rater is an actual location of the rater. Several methods of identifying and of verifying a location of a rater are disclosed. Some methods of identifying a rater's location simultaneously verify the location; other methods of identifying rater's location require subsequent verification by a separate method.

The locality associated with the rater may be, for example, a circle of a specified radius with its center at a location associated with the rater. Several methods of defining a locality around a rater's location are disclosed.

In another example embodiment, a system for qualifying and accepting ratings is disclosed. The system can include an executive component, a verification component, a geocoding component, a storage component, a bus, and at least one processor.

In operation, the executive component accepts a proposal to submit a rating of a business from a rater and identifies a location of the rater. The verification component verifies the location of the rater. The executive component defines a locality encompassing the location of the rater. The geocoding component determines whether the business is within the locality. If the business is within the locality, the storage component stores the rating. The bus enables the foregoing components to communicate with each other. The processor executes the code which implements the foregoing components and the bus.

Other embodiments, systems, methods, features, and aspects will become apparent from the following description taken in conjunction with the following drawings.

### BRIEF DESCRIPTION OF THE DRAWINGS

Embodiments are illustrated by way of example, and not by limitation, in the figures of the accompanying drawings, in which like references indicate similar elements.

FIG. 1 illustrates a method by which an embodiment of the present disclosure receives a rating of a business and verifies that the rater is in a locality associated with the rated business.

FIG. 2 illustrates a locality containing the location of the rater, a local presence of a local business being contained in the locality.

FIG. 3 illustrates several example methods by which the method of FIG. 1 may identify the location of the rater.

FIG. 4A and FIG. 4B illustrate several example methods by which the method of FIG. 1 may verify the location of the rater.

FIG. 5 illustrates a locality whose boundary is defined by a constant straight-line distance from the location of the rater.

FIG. 6 illustrates a locality whose boundary is defined by a constant distance of travel from the location of the rater.

FIG. 7 illustrates a locality whose boundary is defined by a constant time of travel from the location of the rater.

FIG. 8 illustrates an example computing system used to implement embodiments of the present disclosure.

### DETAILED DESCRIPTION

The present disclosure acquires ratings of local businesses associated with a locality.

A “rating” is an evaluation of a business according to the opinion of the individual submitting the rating. A rating may include written text, multiple-choice or numeric responses to standardized questions, or both.

A “business” may be any type of organization that provides goods or services to the public or a portion of the public and has a local presence. A business may be a noncommercial organization such as a public library.

A “locality” is a bounded region encompassing the location of the individual submitting a rating.

An individual submitting a rating will be referred to as a “rater.”

A “local presence” of a business is a physical presence of the business contained in a locality. A local presence may be a fixed location, as for a restaurant or store, or may be capable of movement, as for a food truck. In the case of a local presence that is capable of movement, the business may be assigned a nominal location within its area of operation by any means capable of reduction to an algorithm.

“Identifying” a rater's location means determining a nominal location of the rater.

“Verifying” the rater's location means confirming that the nominal location of the rater is an actual location of the rater. In some embodiments of the present disclosure a rater's location may be identified and verified in a single operation. In other embodiments a rater's location may be identified and verified in separate operations, as will later be disclosed in detail.

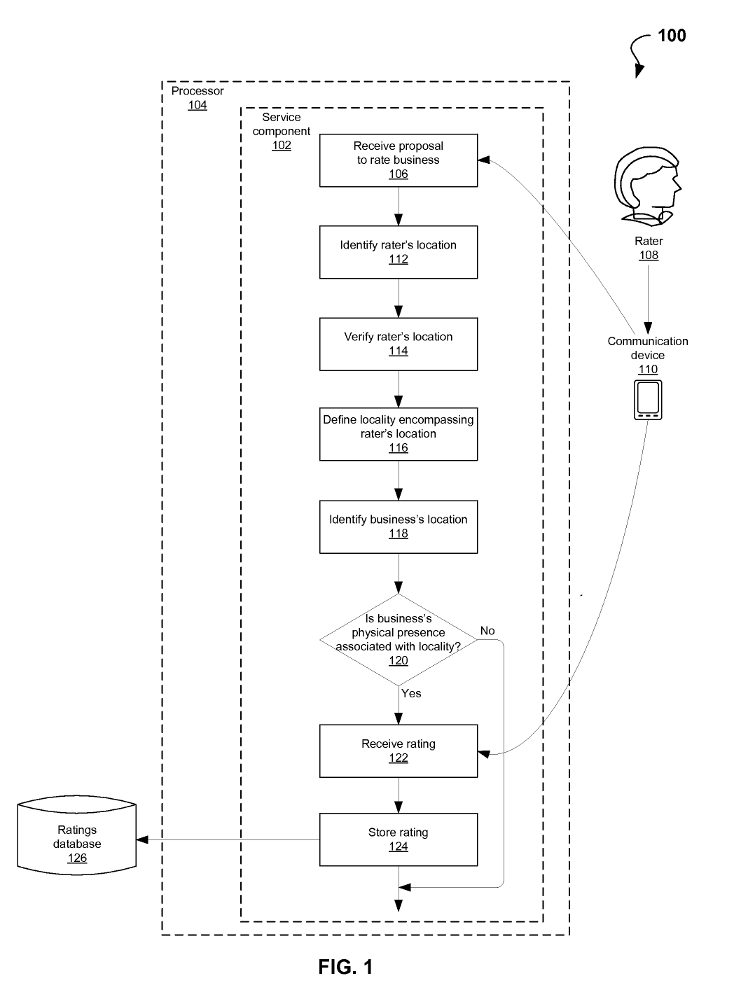

FIG. 1 shows an example method 100 for acquiring ratings of local businesses according to one embodiment of the present disclosure. A service component 102 performs the operations represented in FIG. 1. The service component 102 is a process running on a processor 104.

The service component 102 receives a proposal to submit a rating of a business 106 from a rater 108. The rater 108 communicates with the service component 102 through a device 110 which may be a smartphone, a tablet computer, a personal computer, or any other device capable of exchanging digital information with the service component 102.

The service component 102 identifies the rater's location 112 and verifies the rater's location 114. The service component 102 then defines a locality 116 which encompasses the rater's location 112.

The service component 102 determines the business's location 118 and determines 120 whether the business's location 118 is within the defined locality 116. If the business's location 118 is within the defined locality 116, the service component 102 accepts the rating from the rater 122 and stores the rating 124 in a ratings database 126.

It will be understood that while FIG. 1 shows a single processor 104, the present disclosure may execute on more than one processor. The parts of the method may be divided and assigned to different processors in any manner.

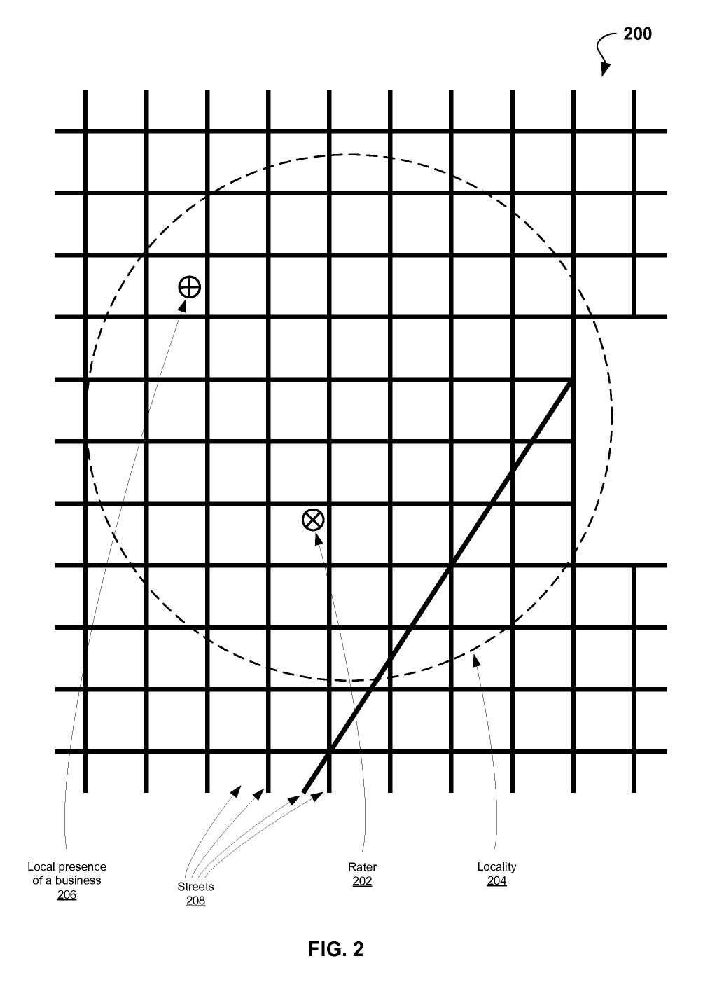

FIG. 2 illustrates the relationships 200 among a rater 202, a locality 204, and a local presence 206 of a business in a grid of city streets 208. The locality 204, being defined with reference to the rater 202, encompasses the location of the rater 202. Because the local presence 206 of the business is contained in the locality 204, the rater 202 is allowed to submit a rating of the business.

Different embodiments of the present disclosure may define a rater's location in different ways, and a given embodiment may define a rater's location in more than one way, allowing a rater to have more than one location. As an example, one embodiment may allow a rater's location to be a home address of the rater, an employment address of the rater, or the rater's physical location at the time when a proposal to submit a rating is made.

The present disclosure distinguishes between proposing to submit a rating and submitting the rating. In some embodiments of the present disclosure a rater's location is identified and verified as the rater's physical location at the time when the rater proposes to submit a rating. In such embodiments the rater's presence near the rated business qualifies the rater to submit the rating. The rater may submit the rating at the time of the proposal, or may submit the rating at a later time, possibly from a different place, and possibly from a different type of device.

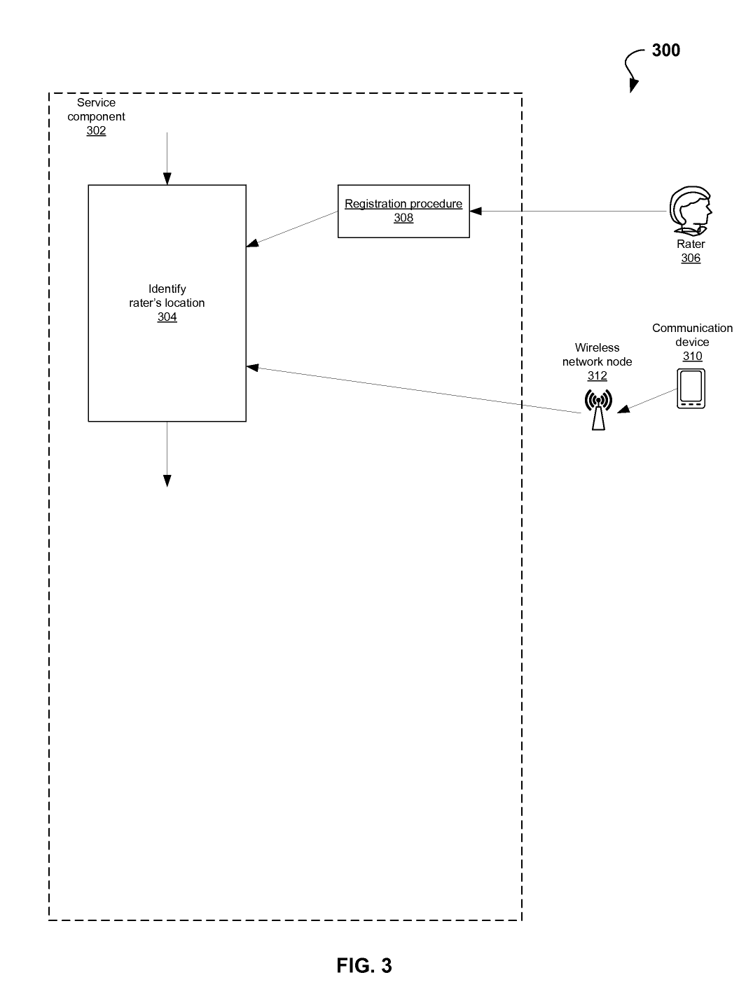

FIG. 3 shows example methods by which the service component 302 may perform the identification process 300.

In one embodiment of the present disclosure, the service component 302 performs identification 304 by the rater 306 reporting a location at or before the time when the rater 306 proposes to rate a business. The service component 302 may perform identification 304 in the course of a registration procedure 308 which the rater 306 must perform one time in order to be allowed to rate businesses.

In another embodiment, the service component 302 performs identification 304 by identifying a wireless network node 312 through which a communication device 310 associated with the rater 306 communicates with the service component 302, the wireless network node 312 having a known location. The service component 302 may identify the wireless network node 312 according to metadata added by the wireless network node 312 to messages originated by the communication device 310. The metadata may consist of identifiers in packet headers. The service component 302 determines the location of the wireless network node 312 and infers that the communication device 310 and the rater 306 are in a region defined by the wireless network node 312's communication range.

In another embodiment, the service component 302 performs identification 304 by determining a location from information provided by a geolocation means in the rater 306's communication device 310 at the time when the proposal to submit the rating is made. The geolocation means may be a GPS receiver, an inertial position sensor, or a receiver of signals from cellular base stations, WiFi base stations, or other types of radio signal sources with limited ranges and known locations.

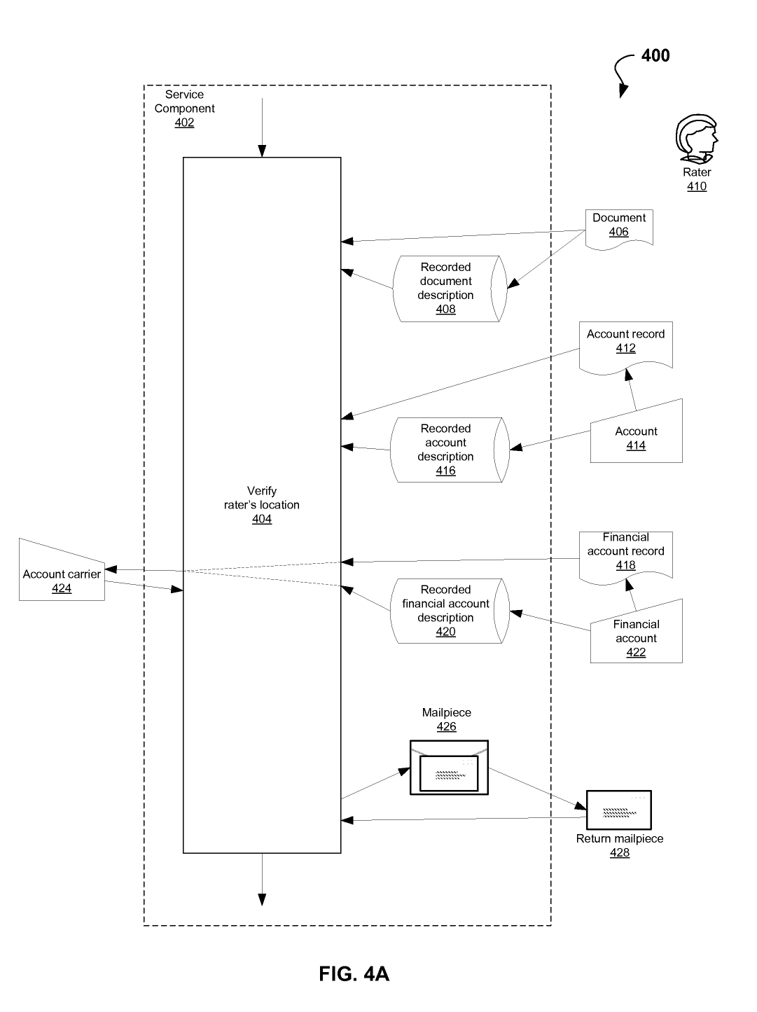

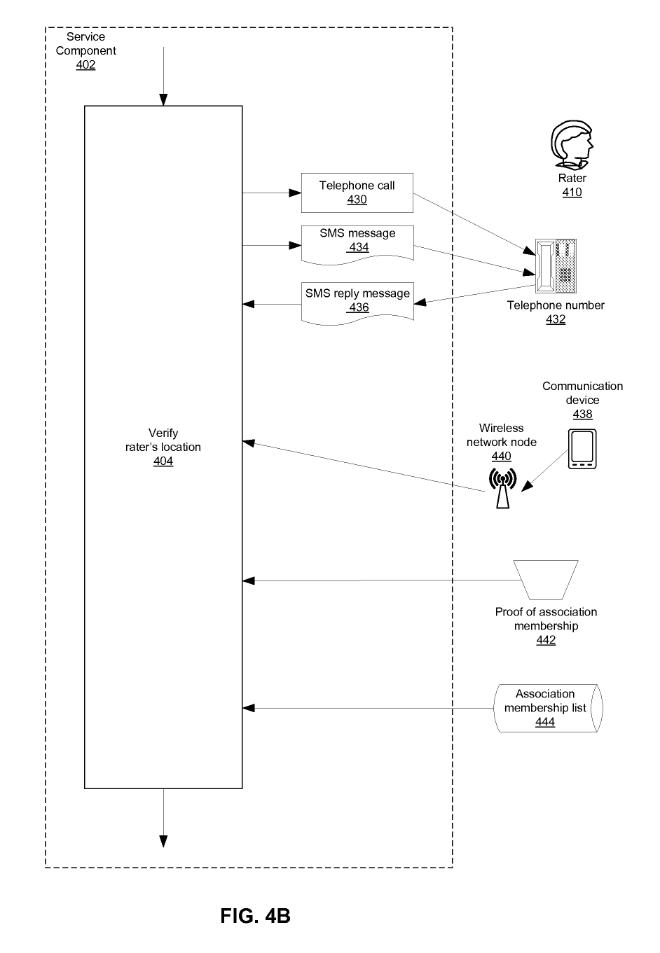

FIG. 4A and FIG. 4B show elements of the present disclosure that may be used in the verification process 400.

In one embodiment, the service component 402 performs verification 404 by reference to a document 406 or a recorded document description 408. The document 406 may be any type of document that associates the rater 410 with a location, such as a driver's license, a government-issued identity card, or a deed which identifies the rater 410 as the owner of property at an address associated with the location. The recorded document description 408 may be any machine-readable representation of the significant elements of the document 406, such as a database of driver's licenses, identity cards, or deeds, the database including identifying information and an address. If verification 404 is performed by reference to a document 406, verification 404 may be performed by a person inspecting the document 406. If verification 404 is performed by reference to a recorded document description 408, verification 404 may be performed by a person inspecting the recorded document description 408, or may be performed automatically by the service component 402. If verification 404 is performed by reference to a recorded document description 408, the recorded document description 408 may be retrieved from a database maintained within the present embodiment of the present disclosure, or may be retrieved from a system external to the present disclosure.

In another embodiment, the service component 402 performs verification 404 by reference to an account record 412 representing an account 414 or a recorded account description 416 representing the account 414. The account 414 may be, for example, a bank account, a telephone service account, or a utility account. The account record 412 may be any tangible record of the account 414 that associates the rater 410 with a location, such as a monthly statement including a billing address or service address. The recorded account description 416 may be any machine-readable representation of the significant elements of the account 414, such as a database of accounts. If verification 404 is performed by reference to an account record 412 of an account 414, verification 404 may be performed by a person inspecting the account record 412. If verification 404 is performed by reference to a recorded account description 416, verification 404 may be performed by a person inspecting the recorded account description 416, or may be performed automatically by the service component 402. If verification 404 is performed by reference to a recorded account description 416, the recorded account description 416 may be retrieved from a database maintained within the present embodiment of the present disclosure, or may be retrieved from a system external to the present disclosure.

In another embodiment, the service component 402 performs verification 404 by reference to a financial account record 418 or a recorded financial account description 420 of a financial account 422, the financial account being a credit card account or a debit card account. Verification 404 may be performed by submitting and then reversing a charge against the financial account 420 to the account carrier 424. The location is verified by information returned by the account carrier 424 in response to the charge.

In another embodiment, the service component 402 performs verification 404 by sending a mailpiece 426 to the rater 410 at an address associated with the rater 410's location. The rater 410 verifies the location by mailing a return mailpiece 428 consisting of at least a portion of the mailpiece 426 to a return address.

In another embodiment, verification 404 is performed by a telephone call 430 to a telephone number 432 associated with the location. The telephone call 430 may be initiated by a person acting on information provided by the service component 402, or by the service component 402 itself. The telephone number 432 may be a landline number providing service at the location or a landline or cellular number with a billing address at the location. The rater 410 or another person who answers the telephone call 430 may verify the location by demonstrating possession of a piece of information communicated privately to the rater 410 by the service component 402 or to the service component 402 by the rater 410. The piece of information may be communicated at any time prior to verification 404, for example, in the course of a registration procedure.

In another embodiment, the service component 402 performs verification 404 by sending an SMS message 434 to a telephone number 432 associated with the location. The telephone number 432 may be a cellular number whose billing address is at the location. The rater 410 or other person who receives the SMS message 434 may verify the location by sending a reply message 436 which demonstrates possession of a piece of information communicated privately to the rater 410 by the service component 402 or to the service component 402 by the rater 410. The reply message 436 may be sent by SMS or by another medium such as telephone or email. The piece of information may be communicated at any time prior to verification 404, for example, in the course of a registration procedure.

In another embodiment, the service component 402 performs verification 404 simultaneously with identification by determining the position of a wireless network node 440 through which the rater 410's communication device 438 communicates with the service component 402.

In another embodiment, the service component 402 performs verification 404 simultaneously with identification by determining the location from information provided by a geolocation means in the rater 410's communication device 438 at the time when the proposal to submit a rating is made.

In another embodiment, verification 404 is performed by confirmation that the rater 410 is a member of an organization whose membership is limited to individuals associated with the locality of the rater 410's identified location. The organization may be, for example, a legally recognized Homeowners Association, a neighborhood residents' organization, or a local business organization. The rater 410's membership in the organization may be verified by the rater 410 submitting documentary proof of membership 442 or by reference to a list of the organization's members 444.

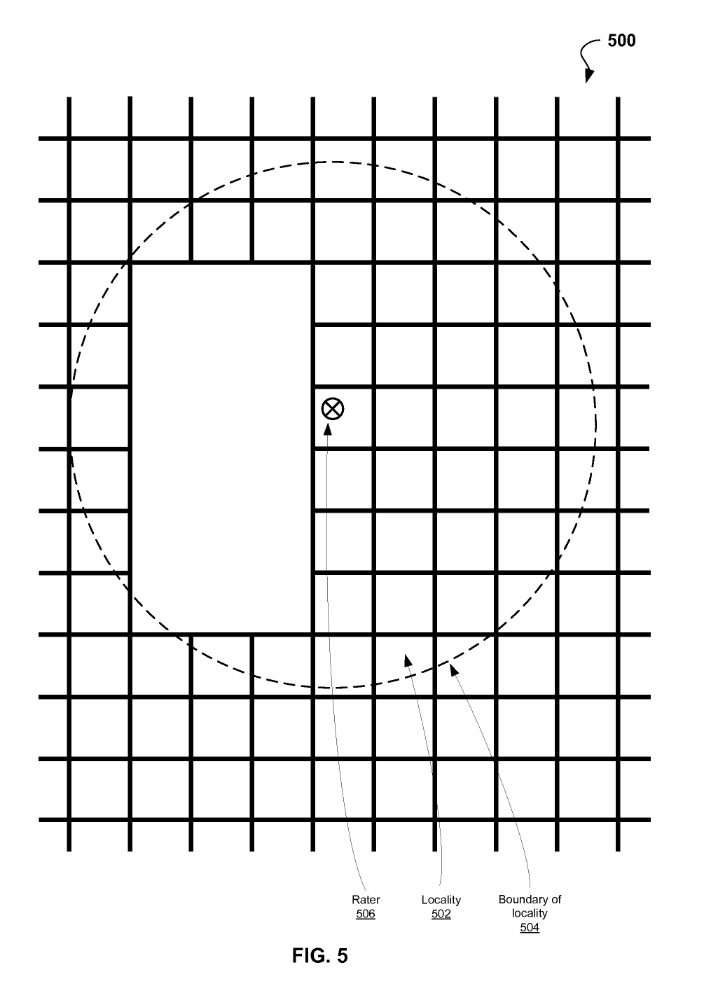

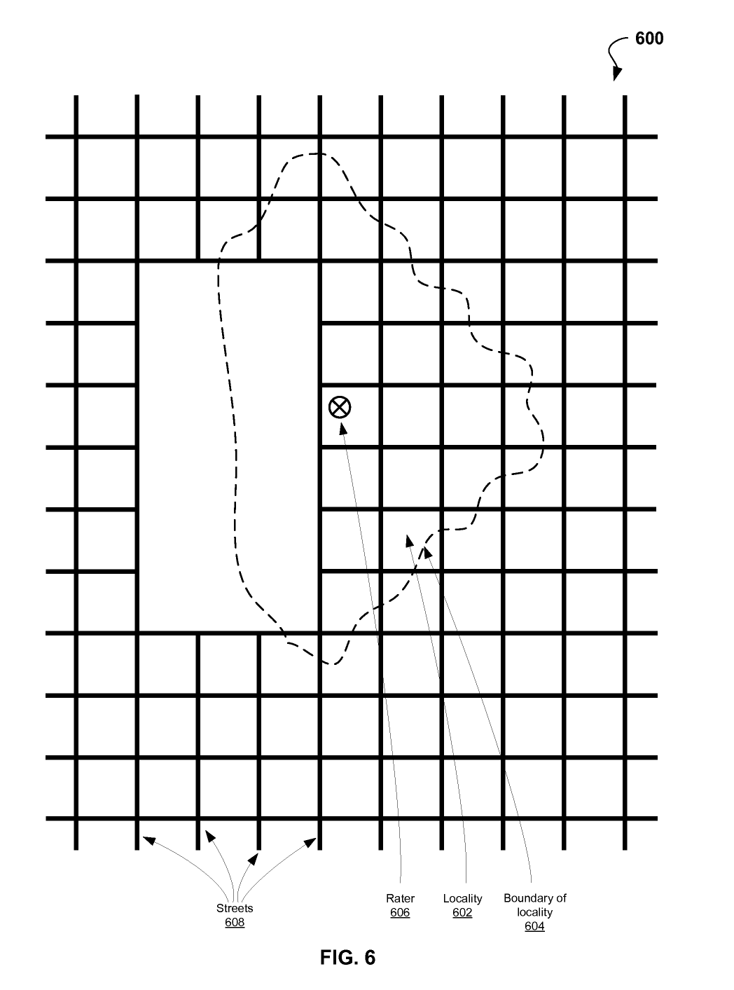

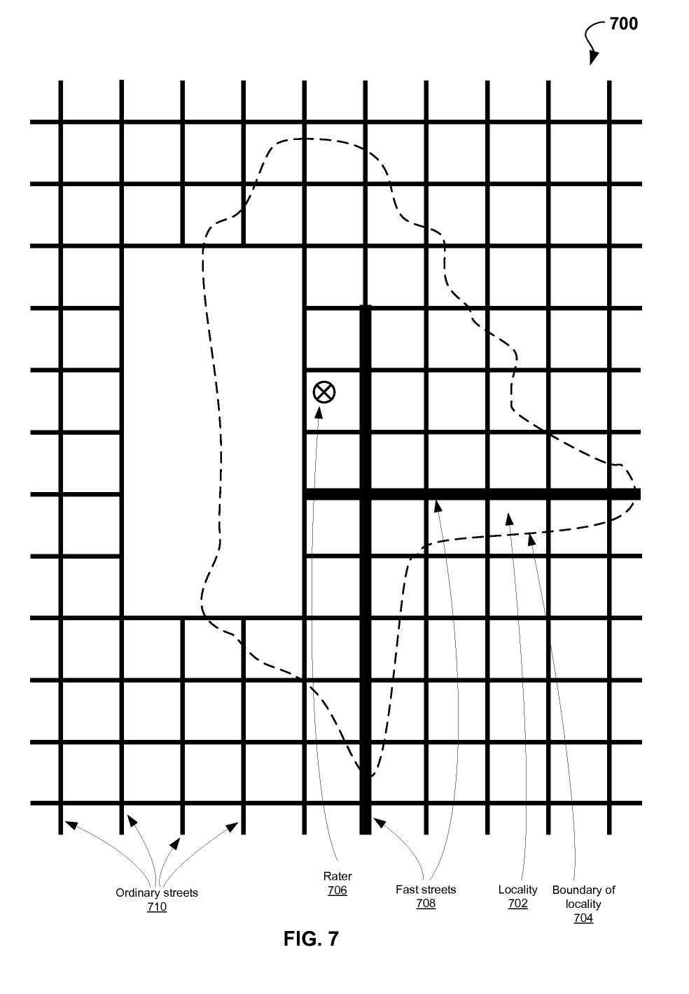

Referring to FIG. 5, FIG. 6, and FIG. 7, the locality 502, 602, 702 of the rater 504, 604, 704 may be determined in a variety of ways.

FIG. 5 illustrates an embodiment in which a boundary 504 of the rater 506's locality 502 is defined by a specified distance from the rater 506's location; that is, by a circle with a specified radius and with a center at the rater 506's location.

FIG. 6 illustrates an embodiment in which a boundary 604 of the rater 606's locality 602 is defined by a specified distance of travel from the rater 606's location. Distances of travel are measured along paths which the rater may use by one or more specified modes of travel, such as foot, bicycle, automobile, and public transportation. More specifically, FIG. 6 illustrates an embodiment in which the rater 606 is assumed to travel by automobile or by foot, and the rater 606's path is constrained to follow streets 608.

FIG. 7 illustrates an embodiment in which a boundary 704 of the rater 706's locality 702 is defined by a specified time of travel from the rater 706's location. More specifically, FIG. 7 illustrates an embodiment in which the rater 706 is assumed to travel by automobile. FIG. 7 shows that the boundary 704 may be farther from the rater 706's location at points that can be reached by paths that utilize fast streets 708 than at points which can be reached only by paths that exclusively utilize ordinary streets 710.

FIG. 5, FIG. 6, and FIG. 7 illustrate only examples of methods of determining a boundary of a locality. Other possible methods will become apparent to those skilled in the art.

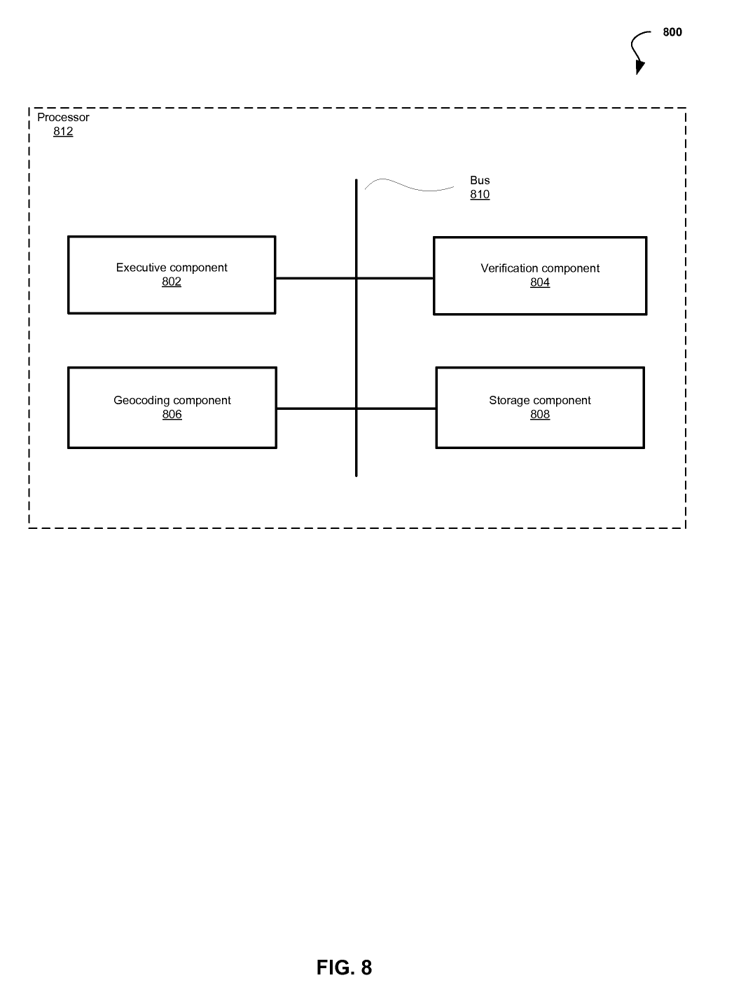

FIG. 8 shows an example embodiment of the present disclosure which is a system 800 whose components are an executive component 802, a verification component 804, a geocoding component 806, a storage component 808, a bus 810, and a processor 812.

The functions of the executive component 802 are to receive a proposal to submit a rating of a business from a rater, define a locality which encompasses the location of the rater, and receive a rating from the rater. In some embodiments the executive component 802 also identifies the location of the rater.

The function of the verification component 804 is to verify that the identified location of the rater is an actual location of the rater. In some embodiments the verification component 804 identifies and verifies rater's location in a single operation.

The function of the geocoding component 806 is to determine whether a local presence of the business is contained in the locality.

The function of the storage component 808 is to store ratings accepted by the system 800.

The function of the bus 810 is to enable communication among the components 802, 804, 806, 808.

The function of the processor 812 is to execute code which implements the components 802, 804, 806, and 808, and the bus 810.

In the system 800's operation, the executive component 802 may identify the rater's location according to one or more of the techniques shown in FIG. 3 and disclosed in the description of FIG. 3, above.

The verification component 804 may verify the rater's identified location according to one or more of the techniques shown in FIG. 4A and FIG. 4B and disclosed in the description of FIG. 4A and FIG. 4B, above.

The executive component 802 may determine the locality of the rater according to one of the definitions shown in FIG. 5, FIG. 6, and FIG. 7, and disclosed in the descriptions of FIG. 5, FIG. 6, and FIG. 7, above.

The present disclosure can be embodied as computer readable code on a computer readable medium. The computer readable medium may be any data storage device that can store data which can thereafter be read by a computer system. Examples of the computer readable medium include read-only memory, random-access memory, CD-ROMs, magnetic tape, optical data storage devices, solid state storage drives, hard disk drives, and carrier waves. The computer readable medium can also be distributed over network-coupled computer systems so that the computer readable code may be stored and executed in a distributed fashion.

Numerous specific details are set forth herein to provide a thorough understanding of the present invention. However, it will become apparent to those skilled in the art that the invention may be practiced without these specific details. The descriptions and representations herein employ common meanings used by those skilled in the art to convey the substance of their work to others skilled in the art.

Also, in this specification, reference to “one embodiment,” “some embodiments,” “other embodiments,” and the like mean that a particular feature, structure, or characteristic described in connection with an embodiment can be included in at least one embodiment of the invention. Different appearances of such phrases in the specification do not necessarily all refer to the same embodiment, nor are separate or alternative embodiments mutually exclusive. Further, the order of blocks in process flowcharts or diagrams, if any, representing one or more embodiments of the invention do not inherently indicate any particular order, nor do they imply any limitations in the invention.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

What is claimed is:

1. A method for acquiring ratings of local businesses, the method comprising:
receiving, by a processor from a rater, a proposal to submit a rating of a business, the business having a local presence;
identifying, by a processor, a location of the rater;
verifying, by a processor, the location of the rater;
defining, by a processor, a locality, the locality encompassing the location of the rater;
determining, by a processor, that the business's local presence is contained in the locality; and
based on the determination, accepting the rating from the rater and storing the rating to a database.

2. The method of claim 1, wherein the location of the rater is verified according to at least one of the following:
reference to one of a document and a recorded description of the document, the document associating the rater with an address of the location;
reference to one of an account and a recorded description of the account, the account associating the rater with an address of the location;
a mailpiece sent to the rater at an address associated with the location, at least a portion of the mailpiece being returned by the rater;
a telephone call to a telephone number associated with the location, the telephone call being answered by a person who demonstrates possession of a piece of information, the piece of information having been communicated privately between the processor and the rater;
an SMS message to a telephone number associated with the location, the SMS message being replied to by a person who demonstrates possession of a piece of information, the piece of information having been communicated privately between the processor and the rater;
a communication device, the rater being in possession of the communication device, the communication device communicating through a wireless network node at the time when the proposal to submit the rating is made, and the wireless network node having a known position;
a communication device comprising a geolocation means, the rater being in possession of the communication device, and the geolocation means reporting the location at the time when the proposal to submit the rating is made; and
confirmation that the rater is a member of an organization whose membership is limited to individuals associated with the locality.

3. The method of claim 2, wherein the document is one of a deed to property at an address associated with the location, a driver's license, and an identity card.

4. The method of claim 2, wherein the account is one of a bank account, a telephone service account, and a utility account.

5. The method of claim 2, wherein the account is a one of a credit card account and a debit card account.

6. The method of claim 2, wherein the organization is a Homeowners Association.

7. The method of claim 2, wherein the rater's membership in the organization is determined by reference to a list of the organization's members.

8. The method of claim 2, wherein the method used to identify the location of the rater is further used to verify the location of the rater.

9. The method of claim 1, wherein a boundary of the locality is defined by one of a specified straight-line distance from the location of the rater, a specified distance of travel from the location of the rater, and a specified time of travel from the location of the rater.

10. A system for acquiring ratings of local businesses, the system comprising:
an executive component operable to receive from a rater a proposal to submit a rating of a business, identify a location of the rater, define a locality, the locality encompassing the location of the rater, and accept a rating from the rater;
a verification component operable to verify the location of the rater;
a geocoding component operable to determine whether a local presence of the business is contained in the locality;
a storage component operable to store the rating;
a bus; and
at least one processor.

11. The system of claim 10, wherein the verification component operates by means of at least one of:
reference to one of a document and a recorded description of a document, the document associating the rater with an address of the location;
reference to one of an account and a recorded description of the account, the account associating the rater with an address of the location;
a mailpiece sent to the rater at an address associated with the location, at least a portion of the mailpiece being returned by the rater;
a telephone call to a telephone number associated with the location, the telephone call being answered by a person who demonstrates possession of a piece of information, the piece of information having been communicated privately between the system and the rater;
an SMS message to a telephone number associated with the location, the SMS message being replied to by a person who demonstrates possession of a piece of information, the piece of information having been communicated privately between the system and the rater;
a communication device, the rater being in possession of the communication device, the communication device communicating through a wireless network node at the time when the proposal to submit the rating is made, and the wireless network node having a known position;
a communication device comprising a geolocation means, the rater being in possession of the communication device, and the geolocation means reporting the location at the time when the proposal to submit the rating is made; and
confirmation that the rater is a member of an organization whose membership is limited to individuals associated with the locality.

12. The system of claim 11, wherein the document is one of a deed to property at an address within locality, a driver's license, and an identity card.

13. The system of claim 11, wherein the account is one of a bank account, a telephone service account, and a utility account.

14. The system of claim 11, wherein the account is a one of a credit card account and a debit card account.

15. The system of claim 11, wherein the organization is a Homeowners Association.

16. The method of claim 11, wherein the rater's membership in the organization is determined by reference to a list of the organization's members.

17. The system of claim 11, wherein the verification component is further used to identify a location of the rater.

18. The system of claim 10, wherein a boundary of the locality is defined by one of a specified straight-line distance from the location of the rater, a specified distance of travel from the location of the rater, and a specified time of travel from the location of the rater.

19. A non-transitory computer-readable storage medium having embodied thereon a program, the program being executable by at least one processor to perform a method for acquiring ratings of local businesses, the method comprising:
accepting from a rater a proposal to rate a business;
identifying a location of the rater;
verifying the location of the rater;
defining a locality, the locality encompassing the location of the rater;
receiving from the rater a proposal to submit a rating of a business, the business having a local presence;
determining that the business's local presence is contained in the locality, and based on the determination, accepting the rating from the rater and storing the rating to a database.
